(19) United States
(12) Patent Application Publication
(10) Pub. No.: US 2008/0105701 A1
(43) Pub. Date: May 8, 2008

(54) Administering of Flowable Products

(76) Inventors: Jan Anders Niss, Malung (SE); Alexander Niss, Malung (SE); Andreas Niss, Malung (SE)

Correspondence Address: NIXON & VANDERHYE, PC, 901 NORTH GLEBE ROAD, 11TH FLOOR, ARLINGTON, VA, 22203, US

(21) Appl. No.: 11/814,313

(22) PCT Filed: Jan. 24, 2005
(86) PCT No.: PCT/SE05/00070

§ 371 Date: Jul. 19, 2007

(51) Int. Cl. G01F 11/00; B65D 88/54; B67D 5/40

(52) U.S. Cl. 222/1; 222/333; 222/380

(57) ABSTRACT

A system for administering flowable products, has a product storage container, supply means for feeding the product from the container and into a feeding channel and for applying a feeding pressure to the product and a product dispensing head to which the product is supplied. An uninterrupted flow of the pressurized product to the inlet of the dispensing head is provided, and a product metering chamber is provided in the actual dispensing head, having a predetermined fixed maximum volume corresponding to that of a product portion to be dispensed and being displaceable as a shuttle between a loading position and a dispensing position wherein the metering chamber is collapsed for dispensing the fixed product volume.

### TECHNICAL FIELD

The present invention relates generally to the administering of flowable products, and specifically relates to a system, a dispensing means, as well as a method for the administering of specified quantities of flowable products.

### BACKGROUND

Various types of equipment for the repeated dispensing of controlled quantities of flowable products from a container have been used for many applications, such as for administering metered quantities of pharmaceuticals, detergents, lubricants, glue and not least food products, such as condiments as well as pastry or cake dough and/or icing. Within said areas the equipment varies from the simplest form of hand held dispenser, such as a hand pump or manual cartridge gun where the product is discharged from a loaded cartridge by manually operating a plunger, and to automated and quite sophisticated dispensing systems. Generally, it may be stated that the simpler, purely manual equipment does not provide any high accuracy in the dosing or metering of the dispensed product and does not permit any dispensing with high frequency. On the other hand, most existing automated systems are not only complex and expensive but also require much space for the installation.

The above mentioned type of automated dispensing systems would appear to be particularly useful within the food industry, and especially so in fast food establishments such as hamburger restaurants. In such establishments there is need for an accurate and selective dispensing of predetermined quantities of condiments of different viscosity, such as sauces, dressings, mustards and mayonnaise, on the food products during preparation thereof. Nevertheless, most establishments within this area still make use of manual devices such as the above mentioned hand pumps and cartridge type guns that may even be refilled at location, from large buckets. Not only is this handling very unhygienic, since the condiments come into contact with air at an early stage, long before the actual dispensing onto a food product, it is also very time consuming. In addition, the inefficient and inaccurate manual metering of the dispensed product does for the most have the result that the dispensed volumes increase, leading to an added cost for the restaurant.

U.S. Pat. No. 5,366,117 therefore discloses one example of an automated system that is primarily intended for dispensing condiments onto food products being prepared. Said patent focuses on providing a hygienic system that maintains the dispensed product in a closed system from its supply container and to the actual dispensing thereof, and that is easy to clean at regular intervals. However, in addition to suffering from said above mentioned disadvantages of being comparatively complex, bulky and expensive, said system does not provide for an accurate volumetric metering and high frequency dispensing of the flowable product. The complexity of said system resides largely in the great number of separately connected components required, such as gas pressure source, pump, regulator and several valves. The insufficient accuracy and speed of said system, with regard to the dosing or metering of specified volumes of the flowable product, is caused by a combination of the design of the dispensing head and the fact that the metering pump is positioned far from the dispensing head. This applies also to the embodiment of said known system that is specifically directed to the use of a portion control module.

Thus, there is a great need within different areas of industry, and specifically within the food industry, for a practically feasible solution that offers means and equipment for securing hygienic, effective and economical dispensing of flowable products.

### SUMMARY

The invention provides a solution overcoming the above discussed problems experienced with the prior known techniques for dispensing flowable products.

It is a general object of the invention to provide an improved system for the accurate and repeated dispensing of fixed portions of a flowable product, which system is compact and inexpensive and is still capable of managing products of various viscosities.

It is a further object of the invention to provide an improved dispensing means for use in the system of the invention.

It is a further object of the invention to provide an improved method of accurately and repeatedly dispensing fixed portions of flowable products of various viscosities, which method permits dispensing at very high rate and with high accuracy.

Briefly, the invention provides a system for administering flowable products, having a product storage container, supply means for feeding the product from the container and into a feeding channel and for applying a feeding pressure to the product and a product dispensing head to which the product is supplied. According to the invention, there is provided an uninterrupted flow of the pressurized product to the inlet of the dispensing head. A product metering chamber is provided in the actual dispensing head, has a predetermined fixed maximum volume corresponding to that of a product portion to be dispensed and is displaceable as a shuttle between a loading position and a dispensing position wherein the metering chamber is collapsed for dispensing the fixed product volume. The suggested system is very compact and provides for a very quick and accurate metering or dosing of the product. The dispensing head is still easily maneuverable and overall user friendly. Therefore, said system provides a unique possibility for efficient and accurate dosing of flowable products of varying viscosity and at high dispensing rate.

According to another aspect of the present invention, there is provided a dispensing head for use in the system of the invention. Briefly, said dispensing head has two relatively displaceably connected pistons that between them form a product metering chamber and that are in turn displaceable in a cylinder between a fixed maximum volume loading position and a collapsible dispensing position.

According to another aspect of the present invention, a method of administering flowable products is provided, wherein a product is fed from a storage container, is pressurized and is fed to an inlet of a product dispensing means from which portions of the product are discharged, and wherein the product is continuously fed to the dispensing means, is selectively introduced into a fixed volume product metering chamber, in a loading position thereof. The metering chamber is then displaced from the loading position, while maintaining its fixed volume, and to a product dispensing position wherein the metering chamber is collapsed to dispense the metered volume of the product.

These and further objects of the invention are met by the invention as defined in the appended patent claims.

Advantages offered by the present invention, in addition to those described above, will be readily appreciated upon reading the below detailed description of embodiments of the invention.

### BRIEF DESCRIPTION OF THE DRAWINGS

The invention, together with further objects and advantages thereof, may best be understood by referring to the following description taken together with the accompanying drawings, in which:

FIG. 1 is a partly schematical illustration of an embodiment of the inventive system for the dispensing of a flowable product;

FIG. 2A is an exploded view of a product dispensing means of the system of FIG. 1;

FIG. 2B is a partly sectioned side view of the product dispensing means of FIG. 2A;

FIG. 3 illustrates in detail a double piston of the dispensing means of FIGS. 2A and 2B, in a partially sectioned side view;

FIG. 4 is a bottom plan view of a secondary forward piston of the double piston of FIG. 3;

FIG. 5 is a bottom plan view of a motor support in the dispensing means of FIG. 2A;

FIG. 6 is a detailed view of parts of a pressure sensor of the system;

FIG. 7A is a partially sectioned view of parts of the dispensing means of FIGS. 2A-B, in a product loading position;

FIG. 7B is a partially sectioned view of parts of the dispensing means of FIGS. 2A-B, in a dispensing position, during dispensing of the product;

FIG. 7C is a partially sectioned view of parts of the dispensing means of FIGS. 2A-B, after completing dispensing of a predetermined volume of the product; and

FIG. 7D is a partially sectioned view of parts of the dispensing means of FIGS. 2A-B, during return to the product loading position.

### DETAILED DESCRIPTION

Exemplary illustrative embodiments of the invention will be described below with reference to the drawing figures. The illustrated, embodiments relate to an application of the inventive solution to a dispensing system specifically designed for dispensing food related products, such as condiments, in connection with preparing sandwiches, hamburgers and other so called fast food. However, it shall be emphasized that the invention is not to be restricted to such an application.

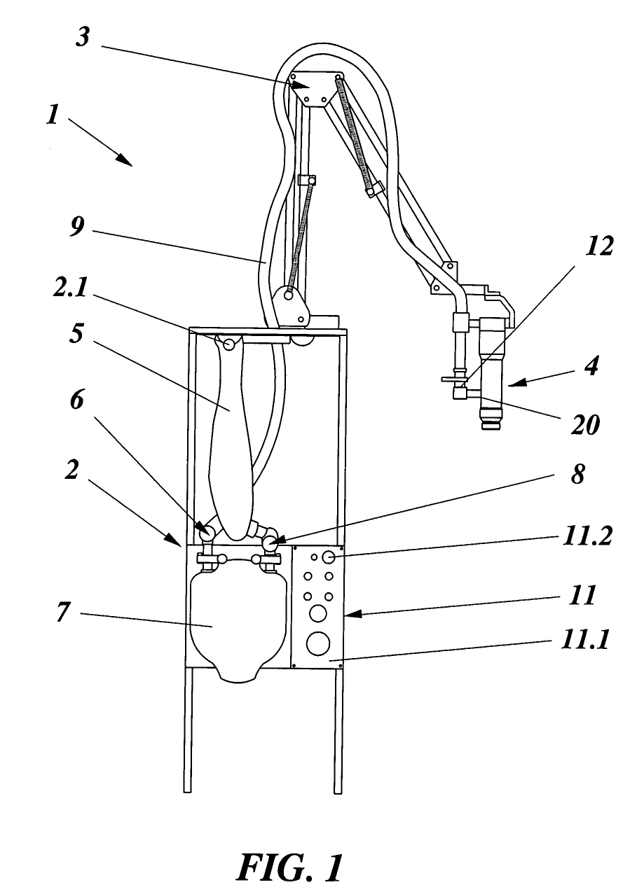

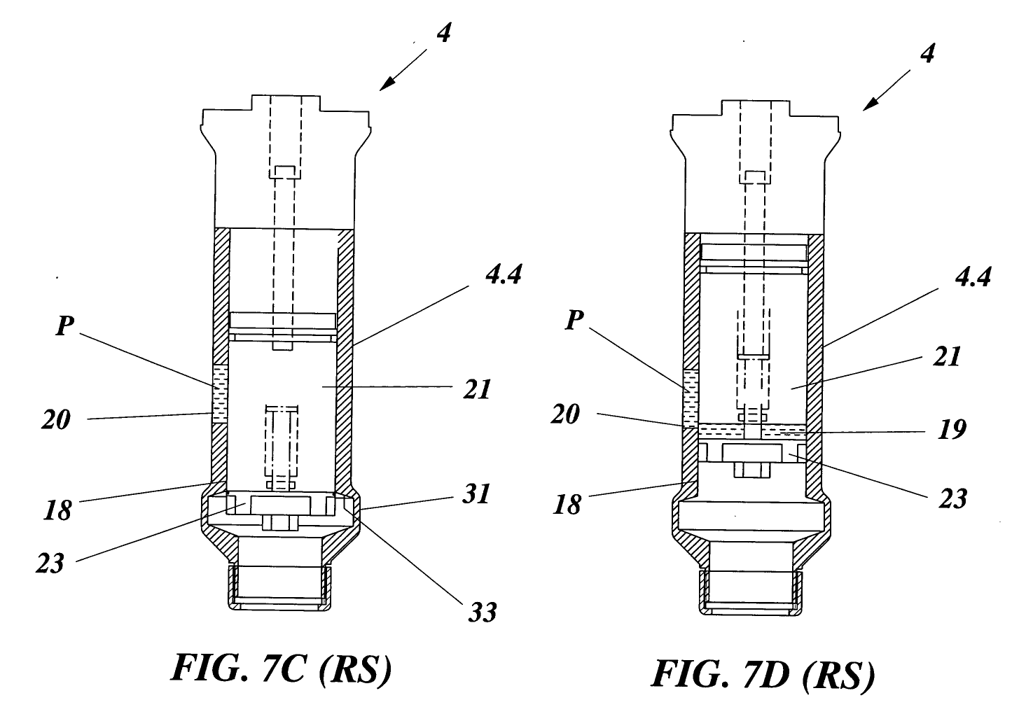

FIG. 1 is a schematical illustration of the complete dispensing system 1 that consists of a frame or stand 2 that in an upper region is provided with a schematically indicated hanger 2.1 from which is suspended a storage container 5 for a flowable product P (see FIGS. 7A-C) that for the present application may be any type of sauce, mayonnaise or dressing used in the preparation of hamburgers, sandwiches, pizza or other “fast food”. It appears from FIG. 1 that the stand 2 has the space and a hanger for an additional storage container in the event that it is desired to be able to switch between two containers in order to secure uninterrupted operation.

The container 5 containing the flowable product P is here a flexible bag type container or “pouch”. The area close to the bottom of the container 5 is connected to an inlet of a supply means 7 through connectors 8 that are of a standard type and therefore do not require any further explanation. The supply means 7 is used for feeding the product from the container 5 to a feeding channel 9 and for applying a feed pressure to the product in the feeding channel. In this application the supply means 7 is a peristaltic pump also known as a hose pump. Such pumps are especially advantageous for pumping food related products, since the product does not come into direct contact with any other part of the pump than the inside of the flexible hose and since they have also unexpectedly proven to be very advantageous for the pumping of products, such as condiments, having very varying viscosity/flow characteristics without causing undesirable shearing or breaking of an emulsion. They are also excellent for pumping products containing solids. A control box 11 containing the necessary control units for controlling the supply means 7 and the later described drive motor 50 is also mounted in the stand 2. Furthermore, the control box 11 has a front panel 11.1 with the necessary controls and indicators, such as a system On/Off button 11.2.

The outlet from the supply means 7 is connected, likewise through standard type connectors 6, to the feeding channel or conduit 9 into which the supply means 7 pumps the product and in which it continuously maintains the feed pressure, as will be explained further below. In this application, at least a section of the feeding channel 9 is formed by a resilient, flexible hose that is connected, again by means of a standard type connector 12, to a product inlet 20 of a product dispensing means or head 4 that will be described below. For easy manipulation of the dispensing means it is mounted for rotation around at least two axes, to the free end of a spring balance arm 3 that is in turn fixed to an upper part of the stand 2.

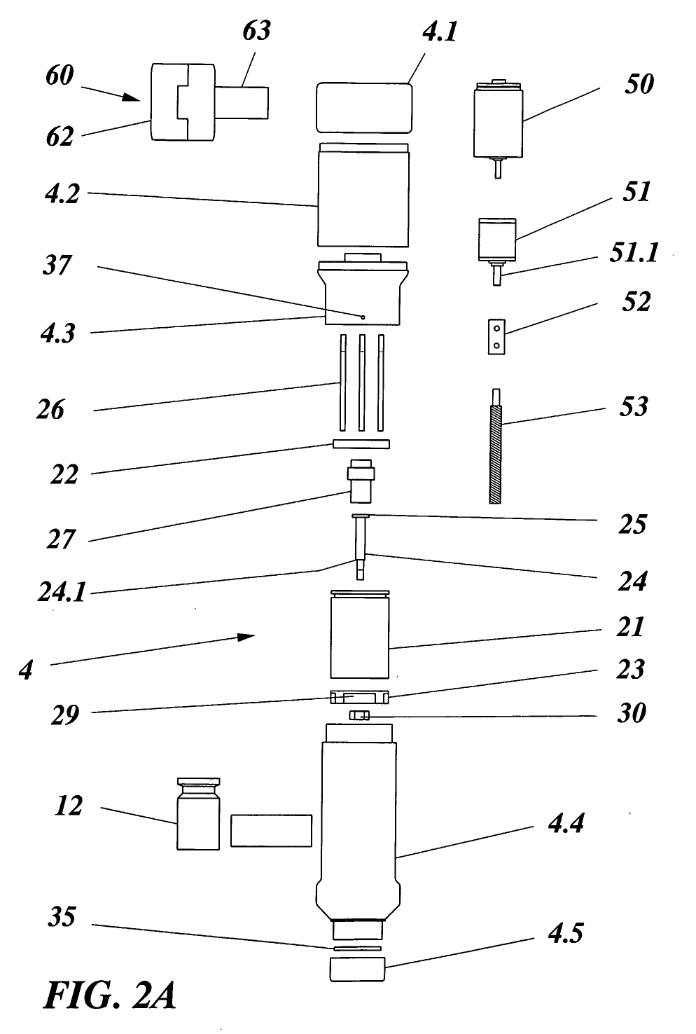

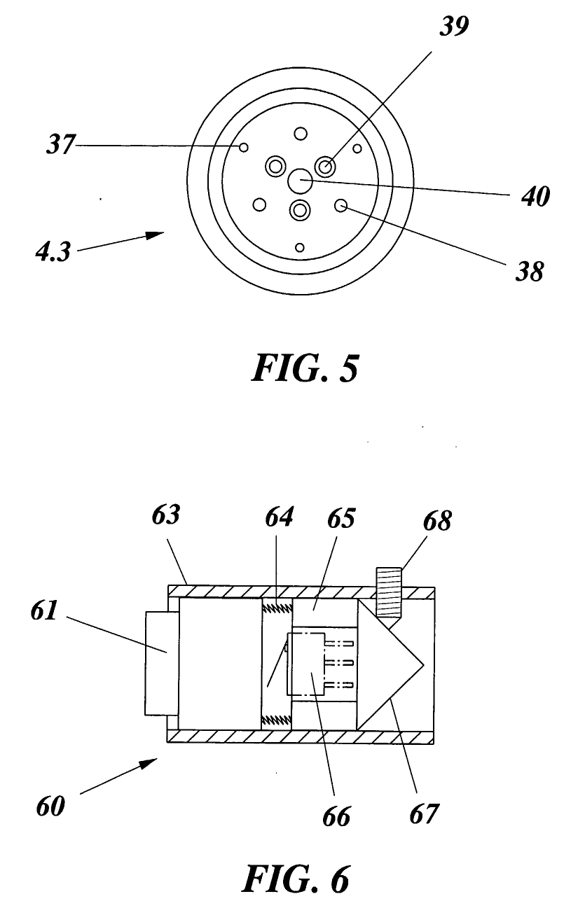

The dispensing means 4 will now be described with specific reference first to FIGS. 2A-B. For reasons of clarity all reference numbers for the parts of the dispensing means 4 have not been inserted in both drawing figures, which should therefore be viewed together. The dispensing means or head 4 consists of a housing comprising an upper two-piece housing 4.1, 4.2 enclosing a drive motor 50 and transmission 51 package that is mounted on a motor support 4.3 by means of bolts (not specifically shown) that are extended through mounting holes 39 (see FIG. 5) extending through the motor support 4.3. The drive motor 50 is electrical but all wiring has been excluded for simplicity. The output shaft 51.1 of the transmission 51 is fixed to a lead screw 53, which extends freely through a central bore 40 in the motor support 4.3, by means of a standard type lock screw connector 52. Thus, the lead screw 53 is supported by the output shaft 51.1 to rotate with the latter.

An upper end of a cylinder 4.4 is connected to the lower end of the motor support 4.3, through a threaded connection that is visible in FIG. 2B. Finally, a union nut type holder 4.5 for an outlet diaphragm 35 is screwed onto a lower outlet end of the cylinder 4.4. The outlet diaphragm 35 is not illustrated in full detail but is preferably of a standard type that is frequently used to avoid dripping from dispensers of different types. The cylinder 4.4 axially displaceably receives a double-piston 21-23 that is guided by an inner cylinder wall 18 and that will be described further below. Close to the lower end thereof the cylinder 4.4 has an increased diameter section 31 having an inclined bottom wall 32 and an upper wall 33 that is likewise inclined, but in an opposite direction. The purpose of this increased diameter section 31 will be clarified below.

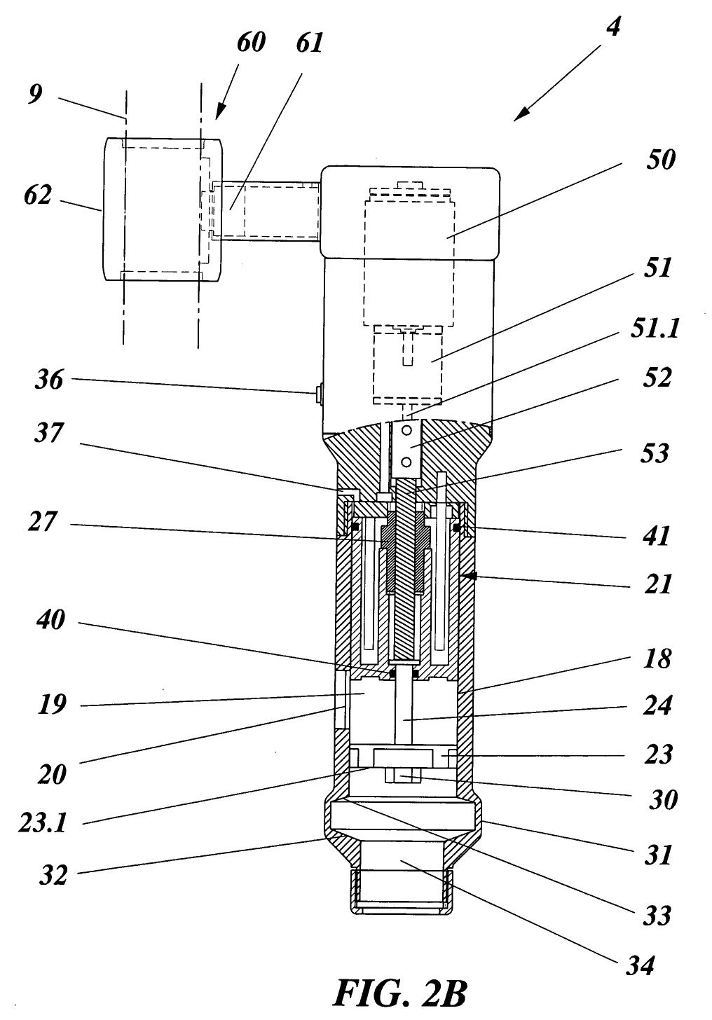

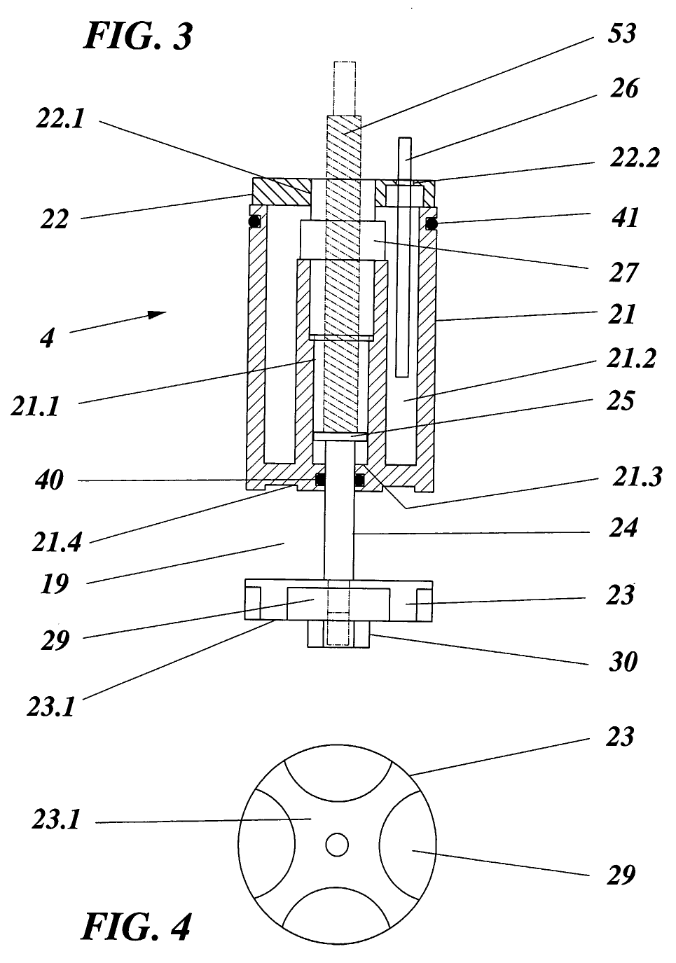

The double-piston 21-23 is illustrated in detail in FIGS. 3 and 4 and it consists of a primary piston 21 having an outer diameter that is slightly smaller than the inner diameter of the cylinder, so that it is displaceable therein with a very close fit. To completely seal the primary piston 21 against the inner wall 18 of the cylinder 4.4 it carries an O-ring seal 41 in a groove extending around its outer periphery. The primary piston 21 has an open top, a central, stepped through bore 21.1 and a ring shaped upwardly open groove 21.2 radially outside of the through bore 21.1. In a large diameter upper part of the through bore 21.1, a lead screw nut 27 is rigidly connected to the primary piston 21, in this embodiment through a threaded connection. The nut 27 has inner threads (not shown) that are complementary to the external threads of the lead screw 53 that in the assembled condition of the dispensing means 4 engages the nut 27. A downwardly open groove 21.4 may be provided in a lower surface of the primary piston 21, for reasons that will be explained below.

The upper end of the primary piston 21 is closed by a guide plate 22 that is formed with a central bore 22.1 having an internal thread. The plate 22 is attached to the primary piston 21 by being screwed onto an externally threaded upper portion of the nut 27. The lead screw passes freely through the central bore 22.1. Radially outside the central bore 22.1 are provided a set of, here three, guide holes 22.2 that are circumferentially evenly distributed and that each displaceably receive one of a corresponding number of guide pins 26, only one shown in FIG. 3. The guide pins 26 are fixed in threaded bores 38 formed in the bottom of the motor support 4.3 (FIG. 5) and in the assembled condition they extend with a relatively narrow fit through the respective guide hole 22.2 and freely into the groove 21.2 of the primary piston 21. Said guide pins 26 will secure that during operation the primary piston 21 will not rotate with the lead screw 53, but will be guided for axial displacement in the cylinder 4.4 upon rotation of the lead screw 53. In this connection it shall also be noted that the space above the primary piston 21 is ventilated to the atmosphere through ventilation bores 37 formed in the motor support 4.3, to secure that the movement of the piston 21 is not resisted by any vacuum or positive pressure in said space above the piston.

The double-piston further comprises a secondary piston 23 that is displaceably connected to the primary piston 21 and that likewise has an outer diameter that is slightly smaller than the inner diameter of the cylinder inner wall 18, to be displaceable therein with a very close fit. It carries a central peg 24, one end of which is secured to the secondary piston 23, such as by means of the illustrated nut 30 and a shoulder 24.1 (see FIG. 2A) on the peg 24. An upper free end of the peg 24 carries an enlarged head 25 and is displaceably received in the central bore 22.1 of the primary piston 21. The major portion of the peg 24 has an outer diameter that is slightly smaller than the inner diameter of the lower end of the central bore 22.1 of the primary piston 21 so that a relative movement of the primary and secondary pistons 21 and 23, respectively, is guided by the close fit there between. In order to fully seal any gap between the peg 24 and the central bore 21.1 an O-ring 40 is preferably positioned in a ring groove opening into said lower end of the central bore 21.1 of the primary piston 21. Above said lower end is formed a step 21.3 in the central bore 21.1, serving as a stop for the enlarged head 25 of the peg 24, and thereby determining the maximum spacing between the relatively moveable primary and secondary pistons 21 and 23, respectively. In the opposite direction, the spacing there between is restricted by the engagement of the enlarged head 25 with the free end of the lead screw 53, and thus depending upon the axial position of the primary piston 21 on the lead screw 53 and therefore in the cylinder 4.4, as will be explained below. Ultimately, at the end of the later described dispensing position DP (see FIG. 7B), the primary and secondary pistons directly engage one another, so that said spacing is zero.

A product metering chamber 19 is formed between the primary piston 21, which sealingly engages the inner wall 18 of the cylinder 4.4 during full displacement of the metering chamber between a loading position LP and the dispensing position DP, and the secondary piston 23 that is displaceably supported in the primary piston. The primary 21 and secondary 23 pistons are relatively displaceable between a fully extended end position, in which the metering chamber 19 is expanded to a fixed maximum volume, and a fully retracted position, wherein the metering chamber is collapsed to a minimum, approximately zero volume.

The secondary piston 23 has a general disc shape, but is provided with a number of, here four, cutouts 29 (FIG. 4) that are formed in a lower surface 23.1 thereof. The cutouts 29 have a generally semicircular shape that is open towards the outer circumference of the piston 23. They extend axially over a major portion of the piston 23, but not fully therethrough, so that the outer periphery of the piston 23 is maintained intact and unbroken at the upper side of the piston. In the dispensing position DP of the dispensing means 4, said cutouts 29 provide a passage for the product P past the secondary piston 23, thereby allowing the product P to be discharged from the metering chamber 19 to flow to the dispensing outlet (34) during the reduction of the volume of the metering chamber 19, as will be explained further below.

In the dispensing means 4 for dispensing defined quantities of the flowable product being supplied under pressure thereto, as described above, the variable volume metering chamber 19 is received in the cylinder 4.4, is formed between the primary and secondary pistons 21 and 23, respectively and varies in size, as defined by the double piston 21-23. Specifically, the metering chamber has an internal volume varying in size between a maximum loading volume in said loading position LP, corresponding at least to a predetermined volume of the product that is to be dispensed, and a minimum, practically zero volume in said dispensing position DP. The drive means 50-53 is activated so that the primary piston 21, which is drivingly engaged by the output member 53 of the drive means 50-53, and thereby the metering chamber 19 is displaced in the cylinder 4.4. The chamber 19 is displaced between the loading position LP, wherein it communicates with the inlet 20 and the feeding channel 9 and is sealed from the dispensing outlet 34, and the dispensing position DP wherein it communicates with the outlet 34 and is sealed from the product inlet 20. During movement of the double piston 21-23 downwardly from the upper loading position LP, as depicted in FIGS. 2B and 7A, the inlet opening 20 is successively closed by the primary piston 21 acting as an inlet valve. In the loading position as well as during this downward movement the secondary piston 23 completely closes the outlet 34 and thereby acts as an outlet valve. In other words, the double-piston 21-23 may be said to have the function of a shuttle containing a fixed volume metering chamber 19 that is moved from the inlet 20 to the outlet 34 where it is collapsed and emptied by decreasing its volume to approximately zero.

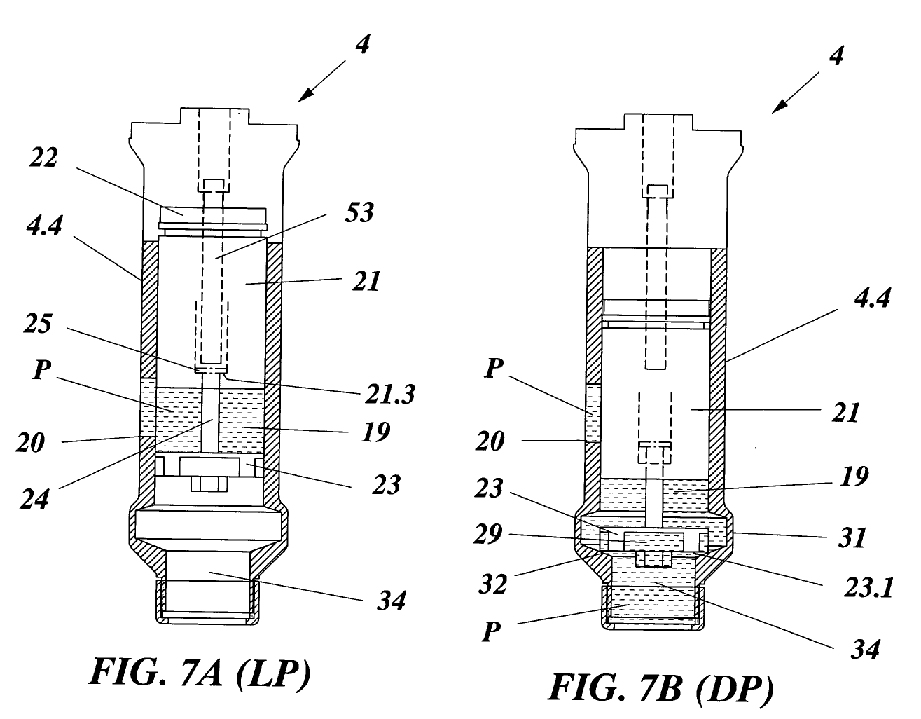

In order to secure proper filling of the metering chamber 19, there is provided a pressure sensor 60 that continuously senses the internal feed pressure in the feeding channel 9 and activates the supply means 7 in the event that the feed pressure falls below a predetermined low value. In the food product application and in combination with the use of a flexible hose forming at least part of the feeding channel 9, it is preferable to use a non-contact sensor 60, such as the one that is illustrated schematically in FIG. 2B and in detail in FIG. 6. This sensor 60 senses the internal feed pressure in the channel 9 by mechanically sensing the expansion of said resilient and/or flexible hose. In particular, the sensor comprises a sensor plunge 61 that is displaceably received in a guide tube 63 that at one end carries a sensor housing 62 and at the other end is fixed to an upper portion of the upper housing portion 4.1. The sensor housing 62 encloses a portion of the hose 9 so that the plunge 61 may engage the outer surface of the hose. The plunge 61 is constantly biased against the hose 9 by means of springs 64 that are attached to a sensor base 65 receiving a micro switch 66 therein. The position of the base 65 is adjustable by means of an adjusting screw 68 engaging an inclined surface 67 of the base 65. Expansion of the hose 9 varies with the internal feed pressure therein, so that the pressure may be constantly sensed by the plunge 61. When the pressure lies within a chosen range, the plunge 61 is moved by the expanding hose 9 against the force of the springs 64 to close the switch 66 and thereby deactivate the supply means 7. Then, when the internal pressure falls outside said range, the hose 9 diameter will be reduced so that the springs 64 push the plunge 61 outwardly to a position where it releases the switch 66 and the supply means 7 is activated again to restore and continuously maintain the feed pressure of the product in the feeding channel 9.

The system 1 comprises means for sensing the arrival of the pistons 21, 23 at the respective end position, namely the loading position LP and the dispensing position DP. Such means may include position sensors (not shown) at the respective end position, which send a signal to a motor circuit upon sensing the arrival of the double piston at said position. Said signal will then cause a reversing of the direction of rotation of the lead screw 53 in both positions and will stop the rotation in the loading position. More preferably, a motor control circuit (not shown) is used that in a known manner changes the direction of rotation of the motor 50 when the resistance to the rotation of the lead screw 53 increases as the double-piston 21-23 reaches an end position and is halted. This increased resistance to the rotation causes an increase of the current and effect supplied to the motor, which in turn causes a resistor to control a transistor that in turn controls the change of direction of the motor 50 in either end position and then stops the motor 50 in the loading position to end the cycle. This solution also protects the drive line in the case that the movement of the pistons 21, 23 would be stopped by a hard solid piece in the condiment in question or for some other reason. In such a case the control circuit would cause the motor 50 to be reversed and the cycle would be repeated.

The operation of the system 1 as well as a method of the invention will now be explained with reference to an illustration of a basic embodiment thereof in FIGS. 7A-D. Said drawings illustrate a lower portion of the dispensing means 4, from the motor support 4.3 down and sectioned from the cylinder 4.4 down, in four different phases of a dispensing cycle. In said embodiment, the cycle starts in a loading position LP of the dispensing means 4, illustrated in FIG. 7A as well as in FIG. 2. In other words, the displaceable product metering chamber 19 of the product dispensing means 4 is positioned in the loading position LP wherein it communicates with the inlet 20. Each time that a cycle is completed the dispensing means 4 automatically returns towards this loading position LP, successively opening the product inlet 20 to allow that the product P is fed into the metering chamber 19. Specifically, the primary piston 21 serves as an inlet valve opening the product inlet 20 in the loading position, successively closing the inlet during the displacement thereof from the loading position LP to the dispensing position DP, closing the inlet in the dispensing position and successively opening the inlet during a return stroke RS back towards the loading position LP. The secondary piston 23 serves as an outlet valve blocking the outlet 34 during the displacement between the loading position LP and the dispensing position DP and opening the outlet 34 in the dispensing position DP.

In the loading position the primary piston 21 has returned to its uppermost position in the cylinder 4.4 by the rotation of the lead screw 53 in the corresponding direction, so that the guide plate 22 engages the motor support 4.3. At this time the secondary piston 23 has been moved to its lowermost position relative to the primary piston 21, wherein the enlarged head 25 of its peg 24 engages the step 21.3 of the central bore 21.1. This is caused by a combination of the engagement of the lower end of the lead screw 53 with the enlarged head 25 as the primary piston 21 returns to the loading position LP, and the force applied thereto by the pressurized product P that is filled into the metering chamber 19 through the inlet 20.

The predetermined minimum feed pressure that is maintained in the feeding channel 9 at least when the metering chamber 19 communicates therewith, secures complete filling of the maximum volume of the metering chamber 19 with the product P, thereby ensuring that an exact, repeated volume of the product P is dispensed in each cycle. When a new portion of the product is to be dispensed, a user presses a start button 36 (FIG. 2B) on the dispensing means 4. This activates the motor 50 to rotate the feed screw 53 in the direction causing the primary piston 21 to move axially downwardly towards the dispensing position DP (FIG. 7B). The metering chamber 19 is filled with the product P under the feed pressure, so that said maximum chamber volume is maintained during this movement, which takes place practically without any resistance, all the way until the inlet 20 is closed by the primary piston 21 wall. Then, the metering chamber 19 is completely sealed between the cylinder 4.4 inner wall 18 and the two pistons 21, 23. Therefore, during this movement from the loading position LP and to the dispensing position DP, the primary piston 21 acts as the inlet valve closing the inlet 20, the secondary piston 23 acts as the outlet valve closing the outlet 34, and the fixed volume chamber 19 is shuttled down towards the dispensing position.

The downward movement of the fixed volume chamber 19 continues until the secondary piston enters the increased diameter section 31 of the cylinder 4.4, immediately above the bottom wall 32 in which the dispensing outlet 34 is formed. The front end 23A of the secondary piston 23 engages and is supported by the bottom wall 32 in said dispensing position DP, to start the dispensing, as is illustrated in FIG. 7B. Since the axial length of the increased diameter section 31 exceeds that of the secondary piston 23 and the inner diameter of the section 31 clearly exceeds the outer diameter of the secondary piston 23, the halting of the piston 23 by its engagement with the bottom surface 32 will open the “outlet valve” to the outlet 34. In other words, continued downward movement of the primary piston 21 will successively collapse the chamber 19, reducing its volume by forcing out the product through the section 31, outside the secondary piston 23, and through the cutouts 29 provided in the front end of the secondary piston to allow dispensing of the product P past the secondary piston and the cylinder bottom wall 32, to the outlet 34 and through the membrane 35.

When the full metered volume of the product P has been dispensed from the chamber 19, the primary piston 21 engages the secondary piston 23, stopping the rotation of the lead screw 53 and causing the direction of rotation of the screw 53 to be automatically reversed, as described. This initiates the return stroke RS, illustrated in FIG. 7C, of the double piston 21-23 and the now fully collapsed metering chamber 19. The primary piston 21 is positively driven or displaced upwardly by the rotation of the lead screw 53 and the secondary piston 23 is caused to move along by adhering to the thin film of the product remaining on the bottom of the primary piston. To enhance this adhering effect, the above mentioned groove 21.4 may be provided in the lower surface of the primary piston 21, securing that an amount of the product P remains therein. However, as it reaches the inner wall 18 of the narrower main cylinder section 4.4, the secondary piston 23 forms a check valve with the cylinder wall 18, closing the product outlet 34 during the return stroke RS toward the loading position LP. This results in a separation of the two pistons 21, 23 and in the creation of a vacuum in the metering chamber 19 during a subsequent phase of the return stroke RS. The starting point of this phase is illustrated in FIG. 7D. This separation of the pistons 21, 23 and expansion of the metering chamber 19 occurs when the lower edge of the primary piston 21 passes the lower edge of the inlet 20 and the bottom end of the lead screw engages the enlarged head 25 of the peg 24 of the secondary piston 23. It has the effect of assisting in filling the chamber 19 with a new “dose” of the product. In this manner the time required for filling the chamber 19 may be reduced and the dispensing frequency or rate may be correspondingly increased. As the metering chamber 19 is filled during the remainder of the return stroke RS it is expanded to its maximum, predetermined volume and the system is ready for another cycle.

By providing an uninterrupted flow of the product, at a chosen minimum pressure, up to the inlet of the dispensing head and by providing the metering chamber in the actual dispensing head, a very compact system is provided. By forming the metering chamber that has a predetermined fixed maximum volume and is displaceable as a shuttle between the loading position and a dispensing position wherein the metering chamber is collapsed for dispensing the fixed product volume, a very quick and accurate metering or dosing of the product is achieved in a dispensing head that is still easily maneuverable and overall user friendly. In testing the invention, with the system configured as described, a dispensing rate of up to 3 portions or doses per second was obtained when working with a low viscosity product such as mayonnaise and the average accuracy in the dosing was higher than 0.1 g. The system was equally well suited for products having solid parts, such as pieces of cucumber or onion, therein. In effect, any solid part remaining between the secondary piston 23 and the bottom wall 32 or the upper inclined wall 33 were easily cut through by the relatively sharp edges of the piston, and could not disturb the dispensing in any way. Thus, the invention as described did well serve the objects of the invention.

The invention has been described in connection with what is presently considered the most practical and preferred embodiment for the intended application, but it is to be understood that the invention is not to be limited to the disclosed embodiments. Thus the invention is not restricted to the use of the mentioned hose pump or the externally provided pressure sensors in applications where contamination or the product is not a problem. In other variants, the dispensing means may be provided with another drive line than the disclosed electrical motor-lead screw, which would serve the same purpose. In applications where the dispensed product does not cause the secondary piston to adhere to the primary piston, a weak spring may be provided in the primary piston, urging the secondary piston to initially follow the primary piston until the check valve is formed. Also, the invention has been described and illustrated herein with specific reference to an application for condiments, but it should be emphasized that it is in no way restricted to such applications. The basic principles of the invention may therefore also be applied to the dispensing of other foodstuffs as well as to other products such as glue or detergent.

The invention is therefore intended to cover various modifications and equivalent arrangements included within the spirit and scope of the appended claims.

1. A system for dispensing flowable products, having a container containing a product, supply means for feeding the product from the container and into a feeding channel and for applying a feed pressure to the product in the feeding channel and a product dispensing means having a product inlet to which the feeding channel is connected, characterized by:
a product metering chamber being received in a cylinder of the dispensing means;
drive means for displacing the metering chamber in the cylinder, between a loading position wherein it communicates with the feeding channel and is sealed from a dispensing outlet and a dispensing position wherein it communicates with the dispensing outlet and is sealed from the product inlet;
said metering chamber having an internal volume varying between a maximum volume in said loading position, corresponding at least to a predetermined volume of the product that is to be dispensed, and a minimum volume in said dispensing position.

2. A system according to claim 1, characterized in that the metering chamber is formed between a primary piston that sealingly engages an inner wall of the cylinder during the full displacement of the metering chamber between the loading position and the dispensing position and a secondary piston that is supported in the primary piston for displacement between a fully extended end position, wherein the metering chamber has its maximum volume, and a fully retracted position, wherein the metering chamber has its minimum volume and in that the main piston is drivingly connected to an output member of the drive means.

3. A system according to claim 2, characterized in that the primary piston serves as an inlet valve opening the product inlet in the loading position, successively closing the inlet during the displacement thereof from the loading position to the dispensing position, closing the inlet in the dispensing position and successively opening the inlet during a return stroke towards the loading position and in that the secondary piston serves as an outlet valve blocking the product outlet during the displacement thereof between the loading position and the dispensing position and opening the outlet in the dispensing position.

4. A system according to claim 2, characterized in that the secondary piston serves as a check valve closing the product outlet during the return stroke toward the loading position, to thereby create a vacuum in the metering chamber during the return stroke.

5. A system according to claim 2, characterized in that the cylinder has an increased diameter section immediately above a bottom wall in which the dispensing outlet is formed and against which a front end of the secondary piston is supported in said dispensing position, in that the axial length of the increased diameter section exceeds that of the secondary piston and by cutouts provided in the front end of the secondary piston to allow dispensing of the product past the secondary piston and the cylinder bottom wall.

6. A system according to claim 1 for dispensing a product being sensitive to contamination or exposure to air, characterized in that the supply means is a peristaltic pump, especially a hose pump, in that at least a section of the feeding channel is formed by a resilient, flexible hose and by a non-contact sensor sensing the internal feed pressure by mechanically sensing the expansion of said flexible hose.

7. A dispensing means for dispensing defined quantities of a flowable product being supplied under pressure thereto, characterized by comprising:
a primary piston being displaceable in a cylinder;
a secondary piston being displaceably connected to the primary piston;
a metering chamber being formed between the relatively moveable primary and secondary pistons and an inner wall of the cylinder;
a drive means connected to the primary piston for positively driving it and the formed metering chamber between a loading position, wherein the chamber communicates with a product inlet in the cylinder, and a dispensing position, wherein the chamber communicates with a product outlet in the cylinder, and in a return stroke back to the loading position.

8. A device according to claim 7, characterized in that the primary piston serves as an inlet valve opening the communication to the inlet in the loading position and successively closing said inlet during part of the displacement thereof from the loading position to the dispensing position, closing the inlet in the dispensing position and successively opening the inlet during the return stroke towards the loading position and in that the secondary piston serves as an outlet valve blocking the outlet during the displacement thereof between the loading position and the dispensing position and opening the outlet in the dispensing position.

9. A device according to claim 7, characterized in that that the secondary piston serves as a check valve closing the outlet during the return stroke toward the loading position, to thereby create a vacuum in the metering chamber during the return stroke.

10. A device according to claim 7, characterized by an increased diameter section in the cylinder, immediately above an inclined bottom wall in which the dispensing outlet is formed and against which a front end of the secondary piston is supported in said dispensing position, in that the inner diameter of the increased diameter section exceeds the outer diameter of the secondary piston, in that the axial length of the increased diameter section exceeds that of the secondary piston and by cutouts provided in the front end of the secondary piston to allow dispensing of the product past the secondary piston and the cylinder bottom wall.

11. A device according to claim 7, characterized in that the primary and secondary pistons are relatively displaceable between an extended position in which the metering chamber is expanded to a fixed maximum volume and a retracted position in which the metering chamber is collapsed to an approximately zero volume.

12. A device according to claim 7, characterized in that the drive means includes a drive motor being drivingly connected to a lead screw that engages a nut being fixed to the primary piston and means for reversing the motor in end positions of the primary piston that correspond to the dispensing and loading positions.

13. A method of administering flowable products, wherein a product being received in a container, is fed by a supply means from the container, through a feeding channel and to an inlet of a product dispensing means from which portions of the product are dispensed, characterized by the following steps:
continuously maintaining a feed pressure of the product in the feeding channel by the supply means;
positioning a displaceable product metering chamber of the product dispensing means in a loading position wherein it communicates with the inlet and wherein it has an expanded maximum internal volume corresponding at least to a predetermined volume of the product that is to be dispensed;
displacing the metering chamber from the loading position while maintaining its internal volume, thereby interrupting the communication between the feeding channel and said chamber;
continuing displacement of said sealed chamber towards a dispensing position;
halting the metering chamber in the dispensing position wherein the chamber is brought to communicate with a dispensing outlet;
successively reducing the volume of the metering chamber to thereby dispense the predetermined volume of the product; and
successively increasing the volume of the metering chamber to its maximum volume during displacement thereof back to the loading position.

14. A method according to claim 13, characterized by:
continuously sensing the feed pressure in the feeding channel;
controlling the product supply means based on said sensing of the feed pressure to maintain the predetermined minimum feed pressure in the feeding channel at least when the metering chamber communicates therewith;
defining said variable volume metering chamber between two relatively displaceably connected, primary and secondary pistons and a piston receiving cylinder; and
providing a passage for the product past the secondary piston at the dispensing position thereby allowing the product to flow to the dispensing outlet during the reduction of the volume of the metering chamber.

15. A method according to claim 14, characterized by connecting a drive means to the primary piston and by displacing the metering chamber by positively displacing the primary piston in the cylinder by means of the drive means.

16. A method according to claim 12, characterized by creating a vacuum in the metering chamber during a return stroke thereof, thereby enhancing filling of the chamber.

17. A method according to claim 12, for dispensing a product that is sensitive to contamination, characterized by providing a resilient hose forming at least a part of the feeding channel, by sensing the feed pressure in said hose by non-contact sensing of the expansion thereof.

18. A method according to claim 17, characterized by producing the feed pressure in the feeding channel by means of a pump mechanism that does not come directly into contact with the product, preferably a hose pump acting on a hose part of the feeding channel.
